(19) United States
(12) Patent Application Publication
(10) Pub. No.: US 2009/0198507 A1
(43) Pub. Date: Aug. 6, 2009

(54) BEHAVIOR-BASED WEB PAGE GENERATION MARKETING SYSTEM

(75) Inventor: Jay Rhodus, Santa Ana, CA (US)

Correspondence Address: LOZA & LOZA LLP, 305 N. Second Avenue, #127, Upland, CA, 91786-6064, US

(73) Assignee: JAZEL, LLC, Lake Forest, CA (US)

(21) Appl. No.: 12/366,645

(22) Filed: Feb. 5, 2009

Related U.S. Application Data
(60) Provisional application No. 61/026,310, filed on Feb. 5, 2008.

(51) Int. Cl. G06Q 30/00

(52) U.S. Cl. 705/1

(57) ABSTRACT

One feature provides a configurable system that allows web site operators/administrators to dynamically identify consumer behavior, formulate different marketing strategies for the same product depending on consumer triggers, and dynamically generating web pages that present different marketing content to consumers based on their segments. Such configurable system may implement behavior-based targeting (BBT) where different marketing strategies for the same product or service may be defined by a web administrator, and different marketing content may be presented to consumers of the same product based on their identified behavior or interests.

### CLAIM OF PRIORITY UNDER 35 U.S.C. §119

The present Utility Application for Patent claims priority to U.S. Provisional Application No. 61/026,310 entitled “Behavior-Based Web Page Generation Marketing System” filed Feb. 5, 2008, and hereby expressly incorporated by reference herein.

### FIELD

The present invention relates to a configurable online marketing tool that facilitates targeted web page or web content generation based on consumer behavior.

### BACKGROUND

In the marketing world, many techniques have been identified for presenting a product to particular consumers based on gender, age, interests, and/or behavior of the particular consumer(s). Many of these marketing techniques identify a consumer based on a gender, age, interests, behavioral and/or psychological profile and respond to such profile by positioning or presenting a product in a way that is more likely to be of interest to that consumer.

Consequently, marketing techniques typically rely on observation and feedback by a marketer or salesperson to adjust the information presented to a particular or individual consumer. These marketing techniques and adjustment of presentation of product information is not easily extended to online (web-based) marketing since it is difficult to observe consumer interests, reactions, and/or feedback to position product information based on likely-consumer profile.

Some prior art web page generation systems recommend related products to online consumers. For example, online merchants commonly provide services for recommending products (books, compact discs, videos, etc.) to consumers based on a consumer's transaction or the transactions of others. Web page generation systems are also common for recommending Web sites, articles, and other types of informational content to consumers.

For instance, FIG. 1 is a diagram illustrating how a typical online marketing model 100 narrows content for display and, in the processes, loses a substantial percentage of potential online viewers. A website initially has a large number of potential online viewers 102 that may be lost or narrowed depending on the choice of content displayed. An online viewer may land on a page and may search and/or select a particular content within the page. The website often attempts to market to a viewer by displaying “related” content either based on a category selection or on probability (e.g., a history of previous viewers having viewed certain content together). Consequently, various probabilistic decisions 104, 108, 112 are made which narrows the potential online viewers into ever smaller subgroups 106, 110, and 114. That is, at each stage of these probabilistic decisions, the selected content is likely to appeal only to a small percentage of the remaining potential online viewers. Due to the related probabilistic content selection, when the webpage is actually displayed its content is tailored to only a small fraction (e.g., 5% or less) of the potential online viewers, thereby losing a lot of online viewers. When a website displays a webpage with content 116 selected by this probabilistic approach, it seeks to maximize its conversion events (e.g., purchases, clicks, sale amounts, etc.) from all viewers.

According to one technique, such as applied by Google web optimizer, various combinations of content are displayed to different users to determine which combination results in the highest conversion rate for the overall online viewer population. That is, for different viewers, the optimizer system generates different combinations of content to determine which results in the greatest percentage of conversion events. The optimizer system then uses the combination of content that has historically generated the greatest percentage of conversions to generate a webpage for other online viewers. However, this approach fails to appeal to the remaining online viewers for which the web page is not optimized.

According to another technique, such as applied by Amazon, web page generation is based on maximizing sales to viewers by offering related products while visiting a website. In this approach, a viewer searching or viewing one product may be offered other products. However such marketing approach, the additional content (offer of other products) does little to actually convince a viewer to purchase the product in which he/she is interested.

Therefore, while some prior art systems may present related content or products that may be of interest to a particular consumer, these systems fail to provide a configurable system that allows each online web site to truly market a product to consumers based on consumer behavior. As an example, current systems just present similar books with each book content/description being the same every time that book pops up in a search. True marketing is more than just presenting other products that may be of interest to a consumer. Instead, marketing a product involves positioning that product and information/content about that product in such a way that is more appealing to a particular individual consumer seeking to purchase that product.

Consequently, a configurable system is needed that allows web site operators/administrators to dynamically identify consumer behavior for a particular user/consumer, formulate different marketing strategies for the same product or service depending on a consumer profile/behavior, and dynamically generate web pages that present different and/or relevant marketing content for the same product or service to consumers based on their consumer profile.

### SUMMARY

A method and/or apparatus are provided for implementing targeted online marketing strategies on a web site based on consumer behavior. Segments for categorizing consumers may be defined, for example, by an online retailer or website administrator. Triggers may also be defined for placing the consumers into the segments. In one example, segmentation triggers may include website pages and product-related content that, when viewed or selected by the online consumer, trigger the behavioral segmentation of a consumer. Content to be displayed to consumers categorized into each defined segment are also defined, wherein the content is based on a marketing strategy targeting a particular type of consumer. Consumer behavior may be identified for the consumer visiting the web site. For instance, such “consumer behavior” include: selection of an initial web page visited or latest web page visited within a web site, a selection within a current web page, the number of times a consumer visits a web page, how long a consumer spends on a particular web page, and/or a search term used to reach a web site or a search term searched within the website. Such “consumer behavior” may be indicative of consumer interests or characteristics that can be utilized in classifying the consumer into a content segment. The consumer may be categorized or classified into a segment based on interests implied by the consumer behavior. The triggers for each segment can be used to define which consumer is placed into which segment. A web page may be dynamically generated so that it is targeted to the consumer to market a particular product or service to the consumer according to the marketing strategy for the segment in which the consumer is categorized. Consequently, rather than being limited to just a plurality of pre-set or pre-defined web pages, any number of web pages can be generated that are specifically customized to a particular user. For instance, the content of the same web page may be dynamically modified and displayed to consumers according to the segment into which they are categorized. The system may continually reassign a consumer to a new segment based on subsequent consumer behavior in selecting content, categories or links on the web site. Consequently, different consumer behavior results in different content being presented for the same web page.

The method may be implemented as a software tool that may be configured by web administrators to present their products and/or services on their distinct websites. The software tool may allow defining different marketing or sales strategies and targeted web page content for consumers of different behavioral segments.

Additionally, a processing device (such as a computer) may be adapted to implement targeted online marketing strategies on a web site based on consumer behavior. The processing device may include (a) means for defining segments for categorizing consumers; (b) means for defining triggers for placing the consumers into the segments; (c) means for defining content to be displayed to consumers categorized into each defined segment, wherein the content is based on a marketing strategy targeting a particular type of consumer; (d) means for identifying a behavior for the consumer visiting the web site; (e) means for categorizing the consumer into a segment based on interests implied by the consumer behavior; (f) means for dynamically generating a web page targeted to the consumer to market a particular product or service to the consumer according to the marketing strategy for the segment in which the consumer is categorized; and/or (g) means for reassigning the consumer to a new segment based on subsequent consumer behavior in selecting content, categories or links on the web site.

### BRIEF DESCRIPTION OF THE DRAWINGS

FIG. 1 is a diagram illustrating how a typical online marketing model narrows content for display and, in the processes, looses a substantial percentage of potential online viewers.

FIG. 2 is a diagram illustrating how a behavior-based targeted online marketing model selects content for display and, in the processes, retains a substantial percentage of potential online viewers.

FIG. 3 illustrates a method for behavior-based targeted marketing for online commerce.

FIG. 4 is a block diagram illustrating an exemplary network topology in which one or more aspects of the present invention may be deployed.

FIG. 5 illustrates an example of operations between a website database module and a website interface to implement behavior-based targeting of online consumers.

FIG. 6 illustrates a block diagram of a behavior-based web page generation system of the present invention.

FIGS. 7-20 illustrate various screen shots of a software tool that may enable a website administrator to implement behavior-based targeting on a particular website.

FIGS. 21 and 22 illustrate a method and apparatus for implementing targeted online marketing strategies on a web site based on consumer behavior.

### DETAILED DESCRIPTION OF THE INVENTION

In the following description, specific details are given to provide a thorough understanding of the embodiments. However, it will be understood by one of ordinary skill in the art that the embodiments may be practiced without these specific details. For example, software modules, functions, circuits, etc., may be shown in block diagrams in order not to obscure the embodiments in unnecessary detail. In other instances, well-known modules, structures and techniques may not be shown in detail in order not to obscure the embodiments.

In the following description, certain terminology may be used to describe certain features of one or more embodiments of the invention. The term “website administrator” refers to any person or entity that may configure segments, triggers, and/or classify or select content within a software module to generate a web page based upon the behavior of consumers, users, or visitors to the website. The term “consumer” refers to any person or persons that use the Internet or other data and/or communication networks to visit a webpage or website. The term “lead” refers to a website visitor or consumer that has provided personal information to opt-in to a website's contact database.

### Overview—Online Marketing

Marketing generally seeks to present a product or service in a way that it most effectively reaches consumers. This process typically involves identifying various consumer characteristics (e.g., age, gender, income level, consumer knowledge about a product/service, or the needs of such consumer) in order to present the product or service in the most attractive light to the consumer. Such identification of consumer characteristics can be performed by a live salesperson in a one-on-one interaction with a particular consumer. The sales person can gauge these consumer characteristics through conversation and questioning of the consumer. However, such specific consumer characteristics are more difficult to ascertain in the online world. Various features described herein provide ways to mimic the real world direct marketing experience online by considering consumer behavior.

One feature provides a configurable system that allows website operators/administrators to dynamically identify consumer behavior, formulate different marketing strategies for the same product depending on consumer triggers, and dynamically generating web pages that present different marketing content to consumers based on their segments. Such configurable system may implement behavior-based targeting (BBT) where different marketing strategies for the same product or service may be defined by a web administrator, and different marketing content may be presented to consumers of the same product based on their identified behavior or interests.

One feature provides a web page generation system that modifies web page content for the same target web page based on consumer behavior. Rather than having different web pages with distinct content for different consumers, a primary (target) web page may have its content (e.g., marketing information, product profile, product options/features, etc.) generated to target particular consumers based on the behavior of such consumers. This allows all traffic to a website to be driven to a particular target web page rather than to different web pages within the web site.

One feature provides a configurable software tool that enables a web site operator/administrator to define a marketing strategy, determine content and triggers and then implement their unique approach into their implementation of behavior-based targeting (BBT). That is, the software tool allows a web site to directly market a product or service to a consumer much in the same way that a marketer or sales person would do in a real-life interaction with a consumer, where a product and product information are presented to appeal to the interest of a particular type of consumer. Such software tool may classify consumers into groups or segments according to their behavior before and/or after visiting a particular web site, and allow marketing a product differently to consumers in different segments. For instance, up-front dynamic content generation/selection for a primary web page may be based on search terms entered by the consumer into a search engine to reach the primary web page. A consumer is categorized into a “segment” based on the search terms, (where a “segment” defines common marketing content to be displayed to consumers meeting certain behavior or characteristics). Alternatively, the consumer may go directly to a website and based on their behavior on the website may be assigned to a behavioral segment. Regardless of how a consumer enters a segment, the consumer can change segments based on behavior while on the website. That is, dynamic generation of marketing content, product information, and/or how a product or service is marketed to a particular online consumer may be based on current consumer behavior while on the website; i.e., consumer behavior in selecting content, categories and/or links on a current or previously-visited website (based on recency, frequency, and/or primacy).

According to another feature, no prior purchase/selection information or sign-in information are used to assign a consumer to a “segment” or to generate web page marketing content presented to the consumer. A consumer may be reassigned to new “segments” based on dynamic behavior in selecting content, categories or links on a web page. Relevant offers may be generated and presented to a consumer based on the segment to which the consumer is assigned and other content selection information.

### Consumer-Specific Online Marketing—Behavior-Based Targeting

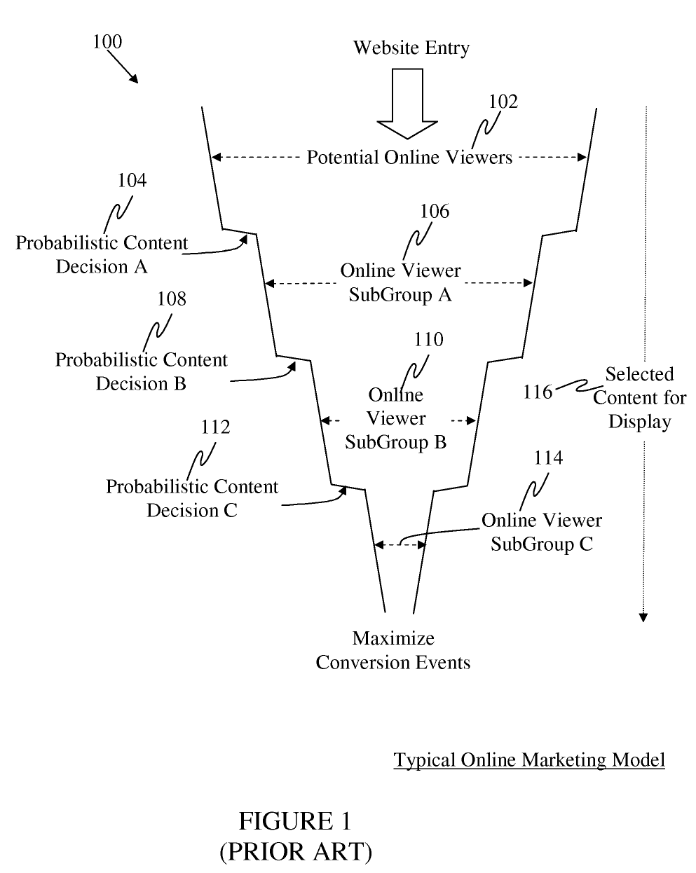

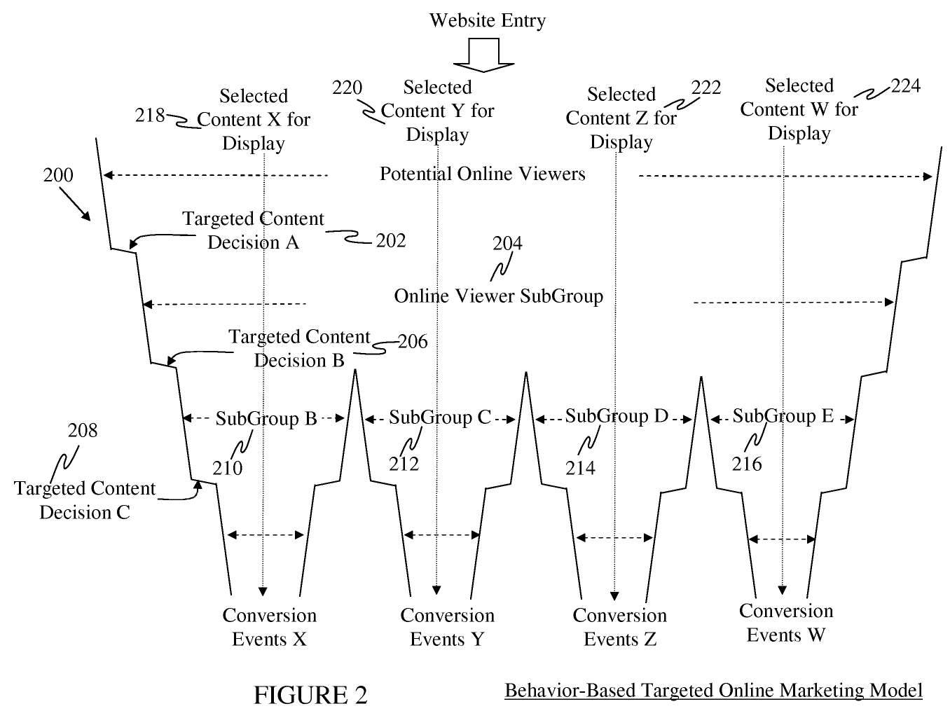

FIG. 2 is a diagram illustrating how a behavior-based targeted online marketing model selects content for display and, in the processes, retains a substantial percentage of potential online viewers. In contrast to the prior art probabilistic online marketing model of FIG. 1, a behavior-based targeted online marketing model 200 is implemented which displays different content for the same product/service on a page according to viewer behavior, thereby increasing the percentage of original potential online viewers that are finally targeted. In this marketing model, a website may use viewer behavior to dynamically generate different content for the same webpage, thereby tailoring such webpage to the online viewer. As the viewer searches for and/or selects content within a website, the viewer's actions and/or selections may be construed as behavior that can be used to generate a webpage with content that is specifically targeted to that type of viewer or consumer. Consequently, as a viewer reaches or traverses a website, the website may make targeted content decisions 202, 206, and 208 which result in dynamically generated targeted web pages being created at each level, where each webpage targets a subgroup 204, 210, 212, 214, and 216. In the example illustrated in FIG. 2, it can be appreciated that at a mid-level, a plurality of viewer subgroups B, C, D, and E are being targeted by presenting the same product or service in a different way (e.g., with content that is most likely to appeal to each of the subgroups). Consequently, a particular webpage may include different content 218, 220, 222, and 224 based on the behavior-based targeting performed. In this manner, a greater percentage of the original potential online viewers are retained by the website.

Conventional online marketing approaches typically seek to appeal to the broadest online audience (viewers). However, these conventional approaches attempt to attract the greatest number of online viewers or maximize overall conversions with the same webpage content. By contrast, the present BBT approach seeks to make a particular product most appealing to a particular consumer or consumer group/segment. Consequently, the same product or service may be presented to a first consumer group using content that most appeals to that first consumer group. The same product or service may be presented to a second consumer group using different content that is most likely to appeal to that second consumer group. By dynamically selecting content for the same web page to appeal to one consumer group or another consumer group, the website increases the likelihood of making the consumer (that has been identified as been in a particular consumer group) purchase the intended or target product. In this example, the same webpage may be populated with different content (218, 220, 222, or 224) according to the segment in which a particular viewer is categorized. Consequently, this approach seeks to maximize the conversion events for each of the identified subgroups rather than the whole set of potential viewers. Because the content presented to the consumers for each subgroup is targeted to a particular type of consumer, it is more likely that a conversion will take place. So the sum of the various conversions may be greater than the conversion rate for FIG. 1.

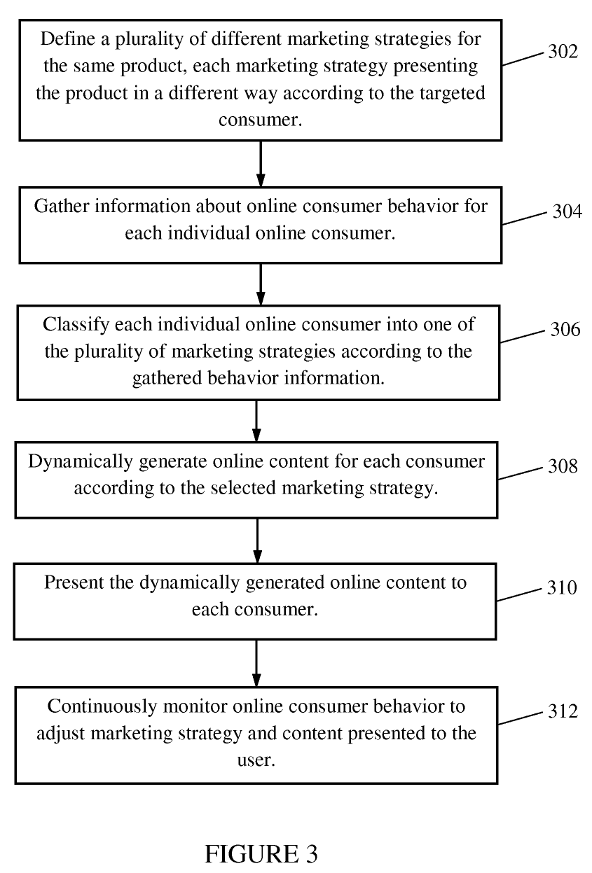

FIG. 3 illustrates a method for behavior-based targeted marketing for online commerce. A plurality of different marketing strategies for the same product may be defined, where each marketing strategy may present the product in a different way according to the targeted consumer 302. The different marketing strategies may be defined by the online retailer for example. Information about online consumer behavior is gathered for each individual online consumer 304. Each individual online consumer may be classified into one of the plurality of marketing strategies according to the gathered behavior information 306. Such consumer behavior information may be used to ascertain or assume individual consumer characteristics, (e.g., gender, age, likes and dislikes, etc.). Online content is then dynamically generated for each consumer according to the selected marketing strategy 308. The dynamically generated online content may be presented or displayed to each consumer 310, e.g., on a website. In this manner, the online retailer can design and execute individualized marketing strategies according to consumer behavior. Online consumer behavior may be continuously monitored to adjust marketing strategy and content presented to the user 312.

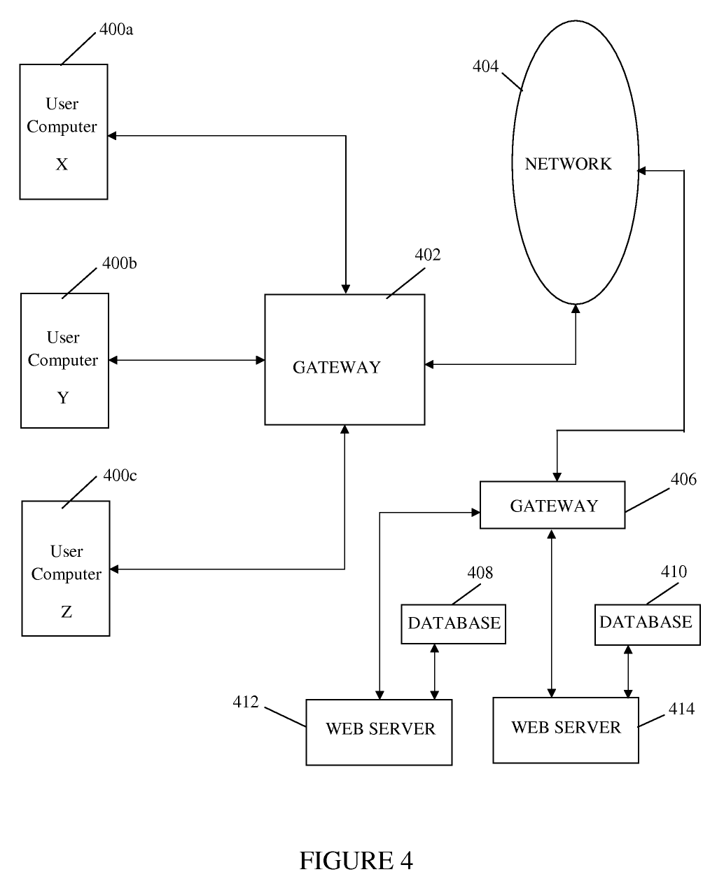

FIG. 4 is a block diagram illustrating an exemplary network topology in which one ore more aspects of the present invention may be deployed. For example, one or more web servers 412 and 414 may operate, alone or in combination, to implement behavior-based targeting of online consumers. The web servers 412 and/or 414 (which functionality may also be application servers and/or database servers) may host one or more web sites that can be reached via a network 404. The web servers 412 and/or 414 may be coupled to one or more databases 408 and/or 410 which may be configured to store content, where the web servers 412 and/or 414 operate to dynamically generate web pages based on such stored content. A web site administrator may configure one or more web sites so that they track consumer behavior and dynamically generate web pages to best position a product or service to a particular online consumer. Consumers may access the web pages or sites in the web servers 412 and/or 414 from user computers 400 via a network 404 (such as the internet) and via one or more gateways 402 and 406. For illustration purposes, three user computers X, Y, and Z 400 are shown connected to the Internet 404 through a gateway 406, where the gateway 406 can interface N number of computers.

In some implementations, the web servers 412 and/or 414 may be operated such that a single centralized service provide hosts the websites and also performs behavior-based targeted content for those websites.

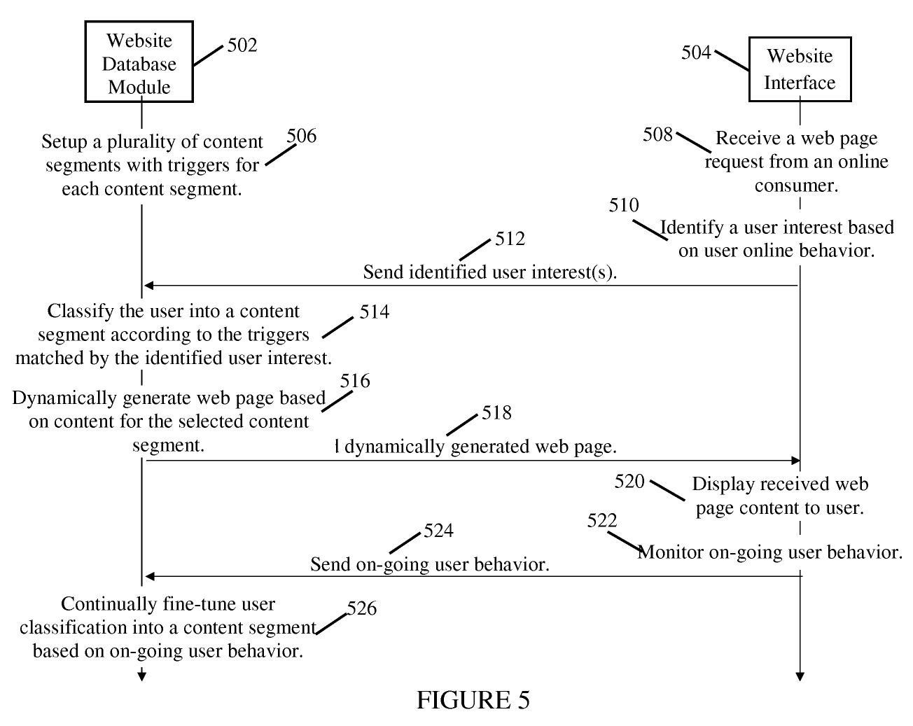

FIG. 5 illustrates an example of operations between a website database module and a website interface to implement behavior-based targeting of online consumers. The website database module 502 may be configured to dynamically generate web pages with content tailored to the particular consumer/user according to the user's online behavior. A website administrator may setup a plurality of content segments with triggers for each content segment 506 on the website database module 502. The website interface 504 may receive a web page request from an online user 508 and may identify user interest based on the user's online behavior 510. The identified user interest is then sent 512 to the website database module 502. The website database module 502 may classify the user into a content segment according to the triggers matched by the identified user interest 514. A web page may then be dynamically generated based on the content for the selected content segment 516. That is, each content segment may have pre-defined associated content that can be used to market or present the same product or service differently to different users. For example, if the user behavior indicates a younger user, a particular car model being marketed may be presented as a sports model in vibrant colors while if the user behavior indicates an older user, the same car may be present as a standard sedan in neutral colors. The dynamically generated web page 518 is sent to the website interface 504 which then displays the web page content to the user 520. The website interface 504 may continually monitor the user behavior 522 and sends the on-going user behavior 524 to the database module 502. The database module 502 may continually fine-tune user classification into a content segment based on the on-going user behavior 526.

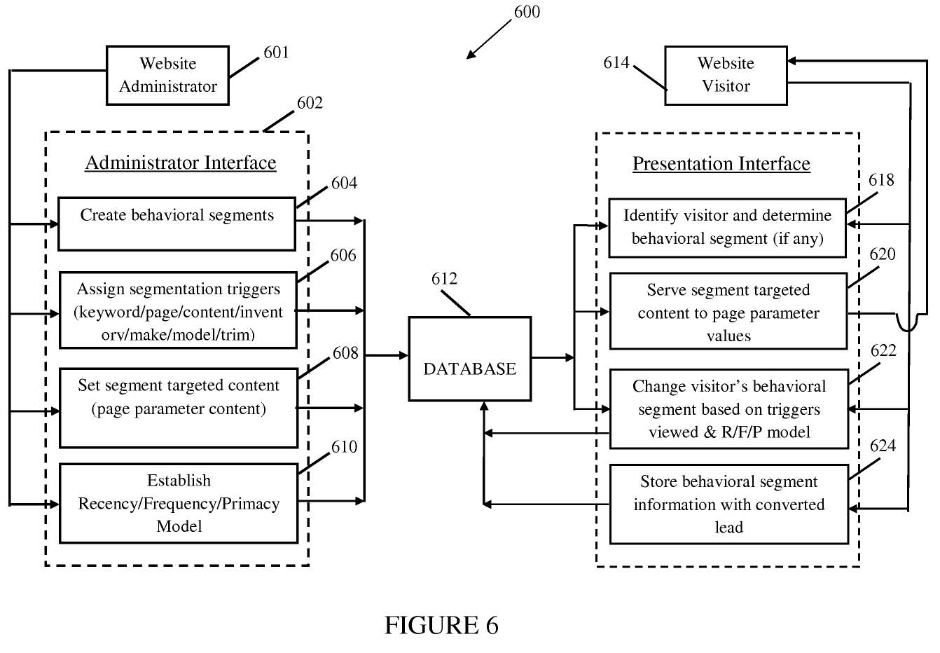

FIG. 6 illustrates a block diagram 600 of a behavior-based web page generation system of the present invention. A website administrator 601 is provided with an interface 602 (or administrator tool) to (1) create and/or define behavioral segments with specific names and descriptions as well and edit and delete existing behavioral segments 604; (2) assign segmentation triggers (i.e. provide a means for assigning web site pages, search engine keywords and product-related content to behavioral segments) 606, the segments may be selected using drop-down menus; (3) set segment targeted content (page parameter values) for each defined behavior segment which provides a means for specifying that content on a web page should be dynamically served based on the consumer's behavior segment 608; and (4) establish or specify whether recency, frequency, or primacy, as described above, shall determine a consumer's behavioral segment 610. All of this information may then be stored in a database 612.

When a consumer 614 enters a website, the consumer is identified and his behavioral segment, if any, is determined using cookies 608. By identifying the consumer and his behavioral segment, the home page (primary web page) itself can serve segment targeted content to consumers as the database 612 serves segment targeted content to page parameter values 620. Based on the triggers viewed and the recency/frequency/primacy model (R/F/P), the consumer's behavior segment may be changed 622. In other words, once a consumer is assigned to a segment, dynamic content generation is based on the consumer's current behavior, i.e., consumer behavior in selecting content, categories or links on a current or previously-visited web page based on recency, frequency, primacy and/or time spent on a web page or viewing a particular content. For example, the most recently visited webpage may be indicative of the consumer's interest. The frequency with which a particular consumer visits a particular page may also be used to indicate a greater or lesser interest in a particular product or service. Also, the first web page visited (e.g., the landing web page) may indicate the most relevant page for that consumer. Lastly, if a user spends a long time on particular web page, this may indicate a greater interest on such content. The system administrator may set a threshold amount of time so that only page visits longer than such threshold amount of time are considered as part of the consumer's behavior. Finally, the changed behavioral segment information, with converted lead, is stored in the database 624.

The use of behavior-based targeting allows a consumer to experience that the visited website and/or web page (which is displaying a product or service in a way that is most suitable to that consumer) is a better fit to their needs and/or interest than if a generic web page content had been presented.

This behavior-based targeting may improve pre-click relevancy (before a consumer has landed on the web site). That is, based on the search terms used to land on the website or the linking web site, a web page may be dynamically generated that targets the consumer by presenting a particular product or service in different ways.

This behavior-based targeting may improve post-click relevancy (after a consumer has landed on the web site) by using such consumer behavior to present content to the consumer in a way that is more appealing to that consumer. So the same web page link, which refers to a particular product and/or service, may have different content or content presented in a different way so that is better targets the particular consumer.

### Sample Behavior-Based Targeting Administrative Tool

In one example, the Administrator Interface 602 may be a configurable BBT software tool that allows website administrators to directly market products and/or services online based on consumer behavior profiles. This software tool allows marketing products/services online much in the same way that they would be marketed in a real-life direct interaction with a consumer. That is, the software tool allows marketing a product or service differently to consumers having different profiles or behavior characteristics. The content presented to a particular consumer may be based on interests implied by the consumer's website behavior. When consumers visit specific website pages from a search engine, they can be placed or categorized into client-user-defined groups (or behavioral “segments”) based on the search keywords used, and then presented with content targeted for that group or segment, where a “segment” defines common marketing content to be displayed to consumers meeting certain behaviors or characteristics. In other words, BBT provides dynamic content generation (i.e., up front) for a primary web page based on the keywords (as defined by the website) entered by the consumer into a search engine. In an alternative implementation, a consumer is only assigned to a segment after visiting one or more website pages according to the content of those pages. The software tool implements BBT to allow marketing a product or service to particular consumers differently based on each consumer's behavior.

In prior art implementations, when a consumer visits a web site to view a product of interest, the web site may display related products on the same page as the product of interest. However, no effort is made to present the same product in different ways to appeal to different types of consumers. That is, most prior art systems merely present other related products. They do not intelligently respond to consumer behavior to position or present a particular product in different ways to appeal to different types of consumers.

By contrast, the BBT software tool of the present invention allows a website administrator to identify consumer behavior, categorize consumers into segments based on distinct consumer behavior or consumer profiles, define different marketing strategies, sales pitches, and web page content to present for consumers categorized in each segment, and dynamically modify the marketing strategy applied to a particular consumer based on consumer behavior in navigating different web pages. This software tool provides a marketing-determined consumer segmentation to serve appropriate content to consumers who visit websites. It allows the website administrator a primary means of marketing the website to target consumers based on marketing-derived consumer delineation.

Although the system and method of the present invention may be described as implemented on websites directed to automobiles, those skilled in the art will recognize that this is by way of example only and that the principles and teachings described herein may be applied to websites directed to any subject matter.

In one example, the configurable software tool allows website administrators to set up segments, determine triggers/pages (i.e., if a customer goes to a particular page) and determine what content (i.e., offers, images, text, audio, video, etc.) is displayed for each segment. The website administrator may also determine how a consumer is assigned to a segment based on the consumer's behavior on a website, for example the frequency of which a consumer visits a particular segment page, the last web page viewed or the first web page viewed. In one example, a web administrator may configure a website to place visitors (consumers) into segments based on the frequency of webpage visits (e.g., behavior) with particular content. For instance, in a website directed to a Chrysler®/Dodge® dealership, visitors (consumers) may be segmented or classified based on the two makes of automobile that are available on the website (Chrysler® and Dodge®). Consumers who visit mostly Chrysler® web pages are placed into the Chrysler® segment; those who visit mostly Dodge® web pages are placed in the Dodge® segment. Once associated with a segment, the consumer may be presented with either Chrysler® or Dodge® related marketing content and/or product information on the home (primary) web page and several other pages based on the segment to which they belong. New consumers or those who have not exhibited a particular behavior may be placed into a default segment which displays Chrysler®/Dodge® web pages.

In addition, the website administrator may also determine how a consumer is assigned to a segment based on the consumer's behavior in entering a website. In one example, if a consumer is directed to a specific website from a search engine, the system of the present invention analyzes the consumer's behavior up front rather than after the fact. For instance, if a consumer is coming to the web site from a search engine, the consumer may be placed into a segment based on keywords that may be used in the search engine.

One advantage of the present BBT system is that it directs consumers to land on the same primary web page, but that primary web page may display different content (e.g., based on the search keywords the consumer used to get to the page, or segment into which the consumer is place, etc.). This allows all traffic to a website to be driven to a particular primary web page rather than to different web pages within the web site. Rather than having different web pages with distinct content for different consumers, a primary (target) web page may have its content generated to target particular consumers based on the behavior of such consumers.

For example, if the consumer uses the search keywords “Jazel Group dealership Hyundai”, Hyundai® content may appear on the primary web page (www.jazelgroupdealership.com) or if the consumer uses the search keywords “Jazel Group dealership Ford”, Ford® content may appear on the same primary web page (www.jazelgroupdealership.com). As a result, the consumer may be presented the exact same primary web page (www.jazelgroupdealership.com) as other consumers; however, the content on the primary web page is dynamically changing based on the search terms used to get to the website (and/or segment to which the consumer is assigned). The consumer could immediately fall into a segment based on the search terms and may remain in that segment until changed by the consumer's own behaviors, as determined by the website administrator. This feature is in contrast to prior art approaches in which a user may be directed to a specific web page (e.g., www.jazelgroupdealership.com/ford_cars; www.jazelgroupdealership.com/hyundai_cars; www.jazelgroupdealership.com/buick_cars, etc.). Such prior art approaches force a web site to have different web pages for each type of content and leads consumers to different web pages rather than to a single target primary web page.

In some prior art systems, such as Amazon.com®, web pages are indexed so if a consumer types in poker books as a search term, if a particular poker book has a high index on a search engine, such as Google®, then that particular indexed web page may appear. So when the consumer selects that web page, that web page displaying that particular book may appear. In other words, it is a specific page for that particular book or set of books. The content is not dynamically generated and presented in the same page with different content, but a separate, distinct web page identified for that specific search term.

With the present BBT software tool, if the consumer goes directly to a web site without the assistance of a search engine, the consumer may be placed into a segment based on the consumer's unique behavior. Unlike prior art systems, the present invention does not use purchase information or sign-in self-selected customer recommendations to place a customer into a segment. For each segment, the website administrator may define a different marketing strategy for the same product or service, so that the content (e.g., product information, product profile, sales pitch, etc.) presented to consumers in each segment may be different. That is, depending on the consumer segment, a web page may be generated to include the marketing content associated with that segment. For example, a particular web site may use one marketing strategy when presenting a particular car to consumers that are interested in a first car model (e.g., Toyota Camry) but utilize a different marketing strategy when presenting the same car maker to consumers interested in a second car model (e.g., Toyota 4-Runner). Consequently, these two types of consumers may be presented with different information or such information may be presented in a different way for the same car maker or even for different versions of the same car model (e.g., hybrid versus sporting sedan). The BBT software tool can thus be used to intelligently define and implement a marketing strategy and deliver targeted product/services content via online websites.

In yet another example, the BBT software tool may be configured to classify a particular web consumer by age, gender, and/or other characteristics or interests. Such characteristics and/or interests may be implied by the consumer behavior in the website and/or other websites. For example, if a consumer is visiting a website browses crash safety and/or baby seat harness information on the website for a particular car, that consumer may be classified in a first segment as a consumer of child-rearing age (e.g., 25 to 35 years old) while if another consumer browses acceleration information and/or sound system information for the same car, that consumer may be classified in a second segment as a younger consumer (e.g., 18 to 25 years old). In this way, the BBT software tool may be configured to imply certain consumer characteristics/interests. Additionally, the BBT software tool may also be configured to directly obtain such consumer characteristics/interests by querying the consumer while visiting a web site.

When a consumer visits a website utilizing the behavior-based web page generation system of the present invention, the consumer is placed into a default segment and may move between segments based on their behavior and they may be presented with relevant offers or content applicable to the segment they are currently in. In one embodiment, the offer may not be immediately displayed but rather it is displayed after the consumer has taken further action. As an example, if a consumer starts at the home page and clicks on a particular section, such as a service section on an automobile dealer's website, they could fall into the service segment but may not immediately receive the service offer. Instead, the behavior-based web page generation system of the present invention may allow the website administrator to present the service offer to the consumer while the consumer is viewing a different page at a later time.

In the present BBT software tool, to define the behavioral segments, i.e. placing the anticipated types of consumers into categories (behavioral segments) for marketing purposes, website administrators may be provided with an interface, also known as an Admin tool. There may be a default segment for first-time visitors/consumers and those visitors/consumers that do not fit in any segments. The Admin tool may allow the website administrator to assign specific web pages, product-related content, and search engine keywords (segmentation triggers) to particular segments. Segmentation triggers may include website pages and product-related content that, when viewed, may trigger the behavioral segmentation of a consumer.

For example, an automobile dealership having a page for available trim packages of a car displaying a Dodge Viper® may be mapped to a different segment than a page for available trim packages of a Chrysler LeBaron®. Pages, content and keywords not assigned to segments may be considered to be in the default segment. The segmentation triggers are used to determine how to categorize consumers who visit websites. In one embodiment, segmented content presentation differentiated by dynamic targeted content within website pages (i.e. all consumer behavioral segments may view the same pages, but the served content may be different based on their segmentation) is provided.

The Admin tool allows the website administrator to set page parameters with different values for each defined behavioral segment. As a result, the content on the pages may be dynamically served (i.e. targeted) depending on the consumer's behavioral segment. This targeted content may include pictures, text, files or any other page parameter type. Page parameters may also have content defined for the default segment—these defaults may specify the appearance of pages to consumers who have not yet been grouped in a behavioral segment.

The website administrator can specify, using the Admin tool, whether behavioral segmentation should be done based on (a) the first page visited (primacy), (b) the most recent type of page visited (i.e., recency), or (c) the most frequent type of page visited (frequency). That is, if a consumer saw 10 Dodge® pages, but the last page they saw was a Chrysler® page, the consumer may be segmented as a Dodge®-type if behavioral segmentation is based on frequency or Chrysler®-type consumer if behavioral segmentation is based on recency.

In the present invention, all pages and content viewed by a consumer may be tracked and used to determine if viewed content puts the consumer into a specific behavioral segment. Segmentation triggers, along with the recency/frequency/primacy specification, as described above, are used to determine whether to change the consumer's current segment assignment.

When a consumer opens any web pages containing segment targeted content, a determination is made as to if the consumer is currently grouped in a behavioral segment. If so, then segment targeted content is used to populate the values of page parameters. If the consumer is not grouped in a segment, or if segment targeted content has not been defined for one or more parameters on the page, then the default content may populate the associated parameter values.

Cookies are used to determine if a consumer has been to the website before. The cookie needs to provide enough information to identify the behavioral segment (if any) associated with returning consumers. In this manner, the home page itself can serve segment targeted content to consumers.

If a consumer has provided personal information to opt-in to a website's contact database, the consumer may be converted to a lead. When a consumer is converted to a lead, behavioral information for the consumer may be added to the lead data. The lead's segment information can then be used by the website administrator for list building, email campaign filters, and for process automation. For example, a Dodge®-type customer would be entered into the Dodge® sales department's pipeline, with activities assigned to, and emails going to, the appropriate sales people.

In one embodiment, the website administrator may define personalized fields to contain dynamic content presented to specific types of consumers as well as define separate pages to be presented to the different behavioral segments. In this manner, the behavioral segmentation can result in presenting different types of web site visitors with completely different content going through the same entry points (e.g. primary web page).

### Sample Behavior-Based Targeting Implementation

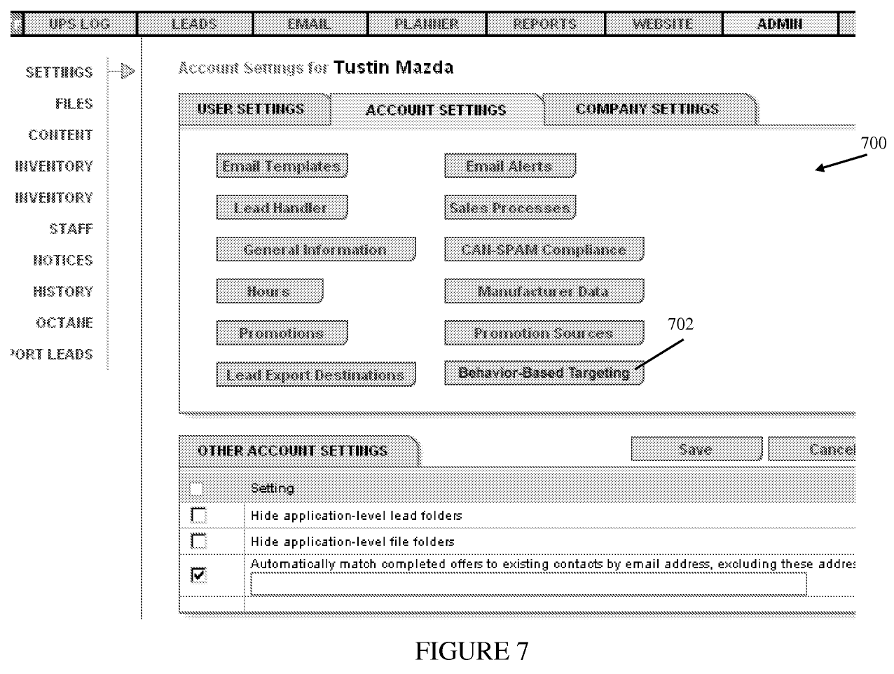

FIGS. 7-20 illustrate various screen shots of a software tool that may enable a website administrator to implement behavior-based targeting on a particular website.

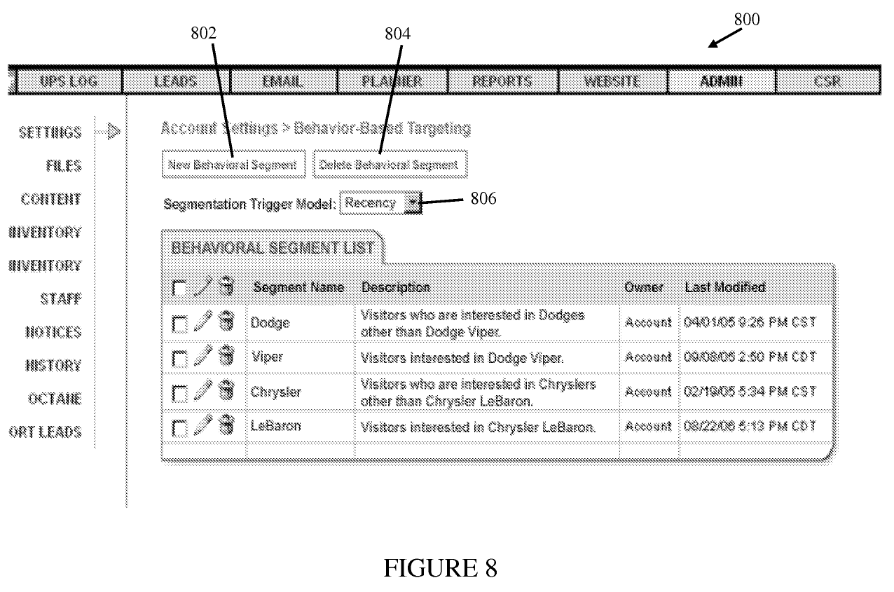

FIG. 7 is an example of a screen shot of an admin/accounting settings screen 700 which includes a link to the admin tool (interface) of the behavior-based web page generation system of the present invention, as described above. Although the link is shown in an admin/accounting setting screen, the link may be included on any screen available to the website administrator. To link to the interface, a behavior-based targeting button 702 may be added to the screen. Selecting the behavior-based targeting button 702 launches a behavior segment list screen 800 (See FIG. 8) which allows a website administrator to add, edit and/or remove behavioral segments, and change the recency/frequency/primacy model, as described above.

FIG. 8 shows an example of previously established segment list which has four behavior segments have been previously defined. The behavior segment list may include information about each previously defined segment, such as the segment name, the description of the segment and the last time the segment was modified. In this example, the four behavior segments include Dodge®, Viper®, Chrysler® and LeBaron®. A new behavioral segment button 802, a delete behavioral segment button 804 and a segmentation trigger model drop down menu 806 may also be included on the behavior segment list screen 800 to allow the website administrator to add a new behavioral segment, delete an existing behavioral segment and select the segmentation trigger.

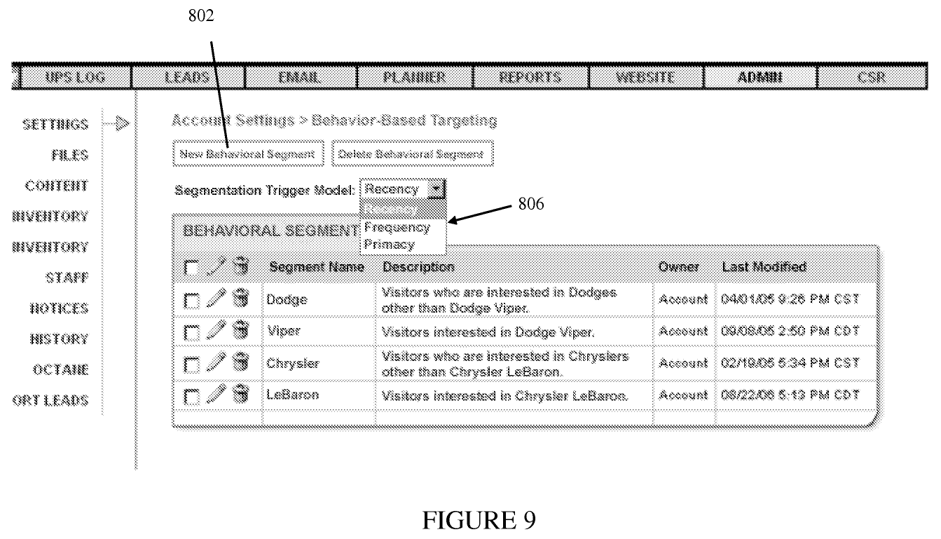

The website administrator may select the segmentation model to determine when a consumer visiting the web site should be placed into a new behavior segment. In one embodiment, the website may select between recency, frequency and primacy as shown in FIG. 9. If recency is selected, the most recently viewed segmentation trigger is used to determine the consumer's segment. If frequency is selected, the segment with the most viewed segmentation triggers may determine the consumer's segment. If primacy is selected, the first viewed webpage or segmentation trigger may determine the consumer's segment.

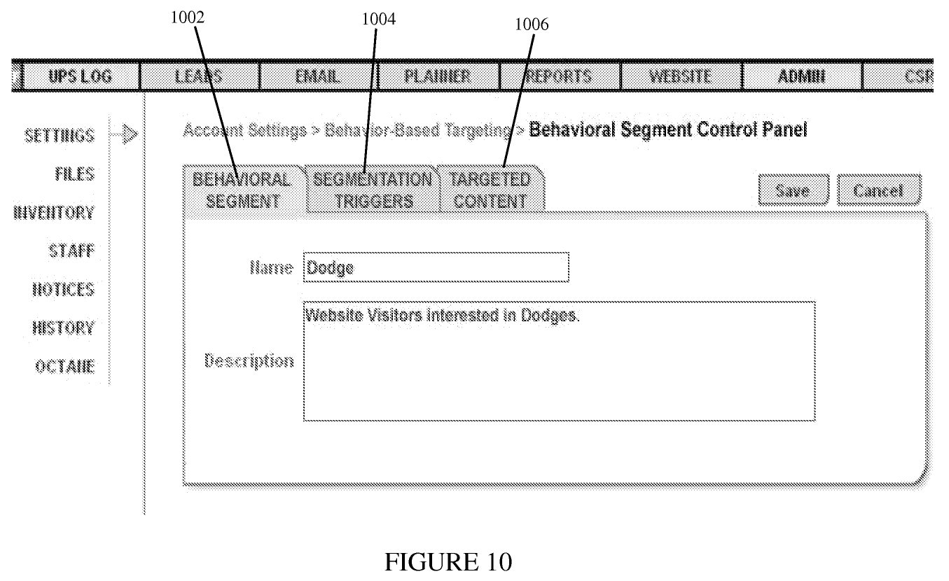

The website administrator may edit a behavior segment by selecting the segment to be edited. For example, as shown in FIG. 10, the website administrator may edit the Dodge® behavior segment. By selecting the edit feature (not shown) from the behavioral segment, a behavioral segment control panel is displayed (See FIG. 10). The control panel may include a behavioral segment tab 1002, a segmentation triggers tab 1004 and a targeted content tab 1006. By selecting the behavioral segment tab 1002, the website administrator may edit the name and description of the behavioral segment.

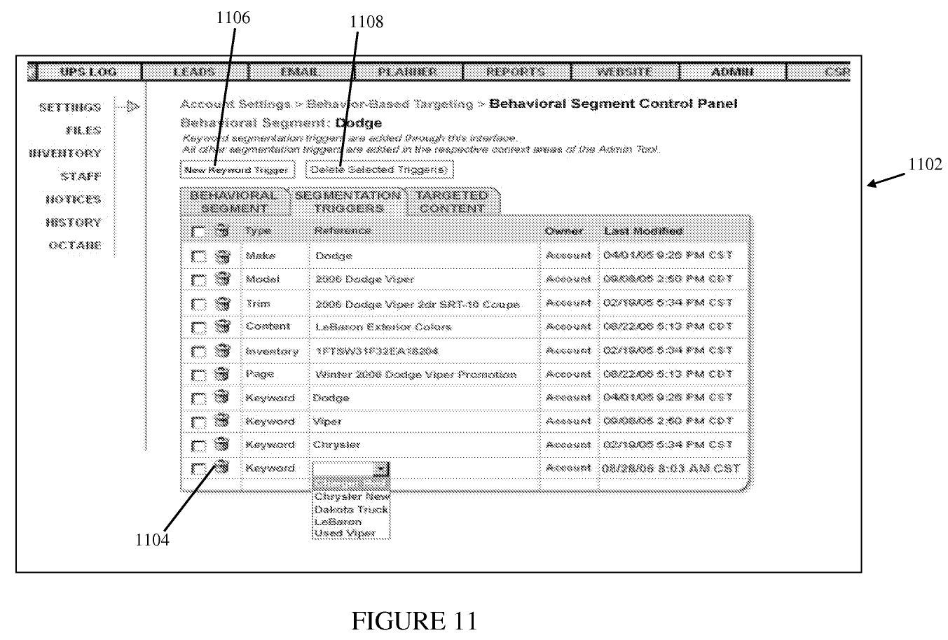

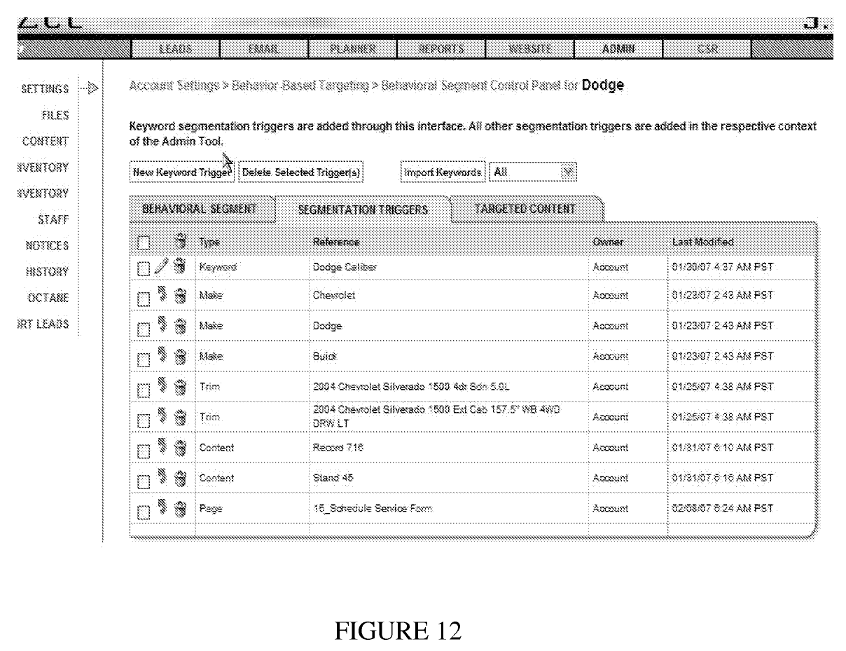

By selecting the segmentation triggers tab 1004 (FIG. 10), a segmentation triggers screen 1102 is displayed, as shown in FIG. 11. (A second example of a segmentation triggers screen is show in FIG. 12.) The screen 1102 includes a list of defined segmentation triggers for the specified behavioral segment such as triggers for pages, content items, inventory items, keywords, or makes, models, or trims. Triggers may be deleted directly from this list by selecting the trash can 1104. Keyword triggers may be created from this screen by selecting a new key trigger button 1106, as described below. The list may be sorted by “Type” by default, but the website administrator can use any column to reorder the list.

The segmentation triggers screen 1102 may include the new keyword trigger button 1106 and a delete selected trigger button 1108. By selecting the new keyword trigger button 1106, the website administrator may select from a drop-down list of keywords (this contains all keywords that have been used to get to this site). The website administrator may also be allowed to type in a keyword if they can't find it in the list. Once the modifications are complete, the website administrator may select the save button (not shown) which may direct the website administrator to the previous screen.

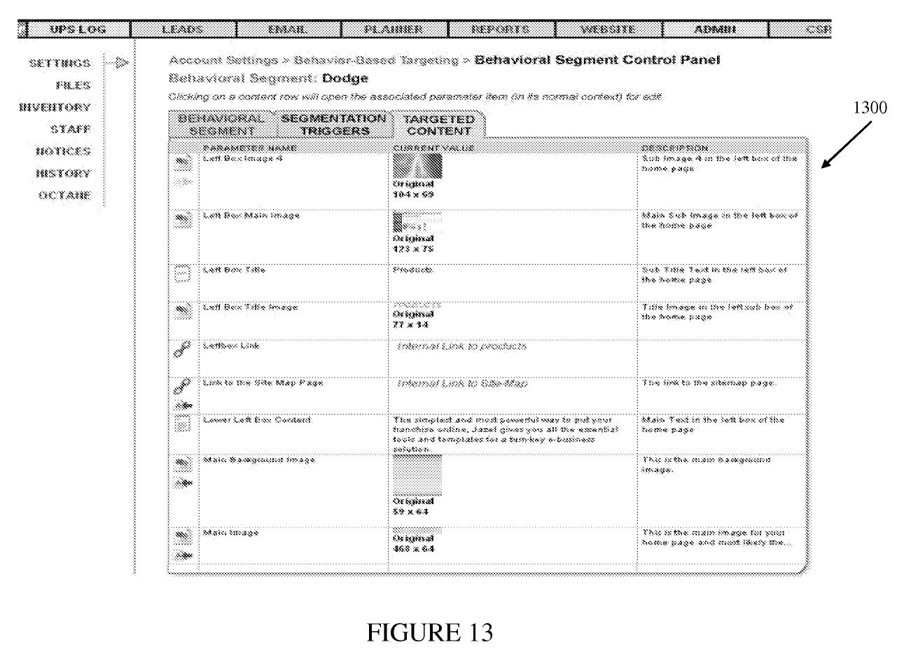

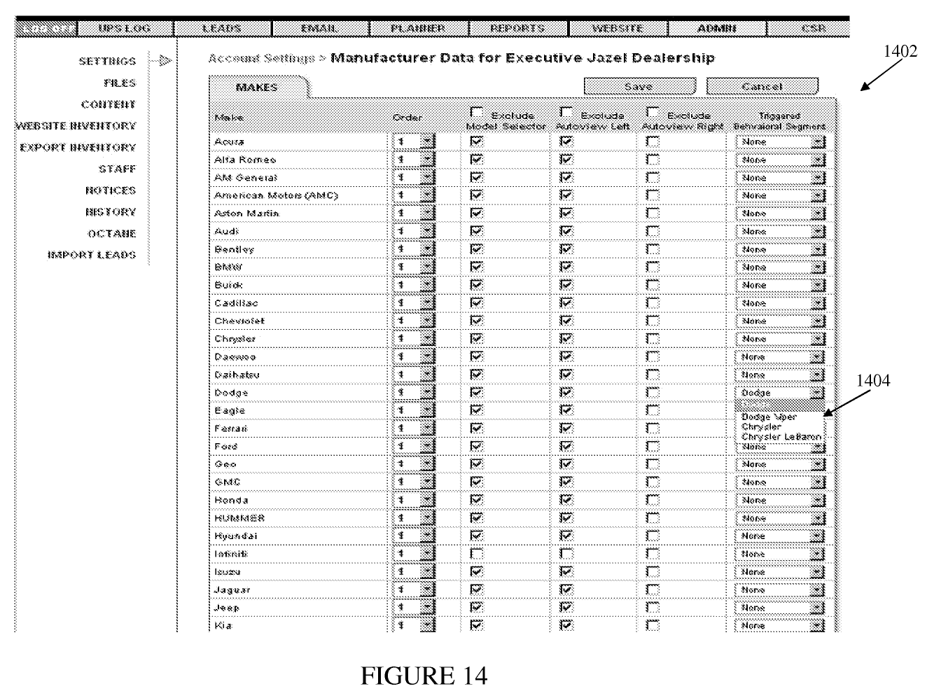

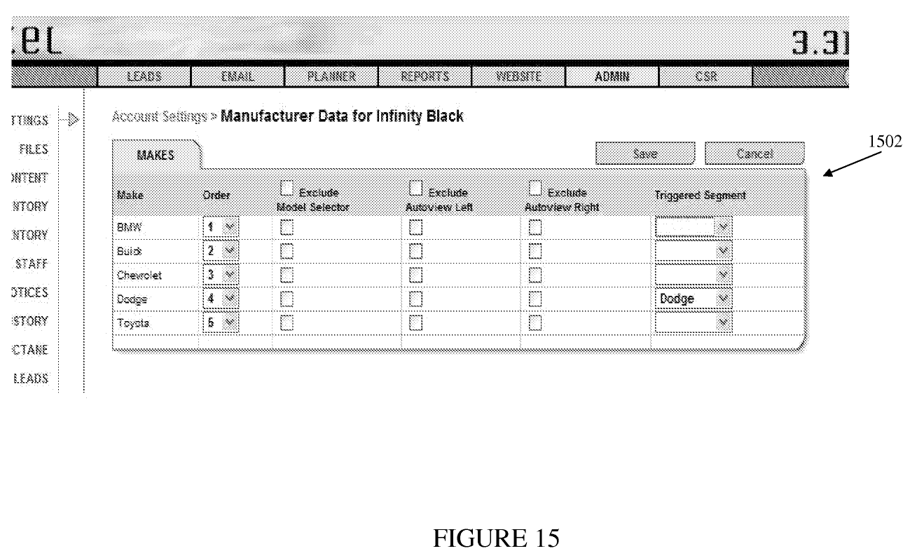

When the targeted content tab 1006 (FIG. 10) is selected, a targeted content screen 1300 as shown in FIG. 13 is displayed. It shows the list of all defined targeted content for the specified behavioral segment. The targeted content items are page content parameters from any page on the administrator's website. In one embodiment, the targeted content items may not be edited or deleted directly from this list. In one embodiment, clicking on the row may open up the associated page content parameter in its normal context for editing. The bread crumb trail (i.e., tree structure path) should allow the website administrator to retrace their steps after editing the parameter to get back to this list. Only page parameters for which specific values have been defined for the specified segment may be displayed in this list. FIGS. 14 and 15 show examples of screen shots of segmentation triggers related to the make of an automobile that are active for a particular website. A triggered behavioral segment column 1402 may be included in this listing. In each row, the trigger column 1402 may contain a drop-down list 1404 of available segments to specify as triggered by the specific make.

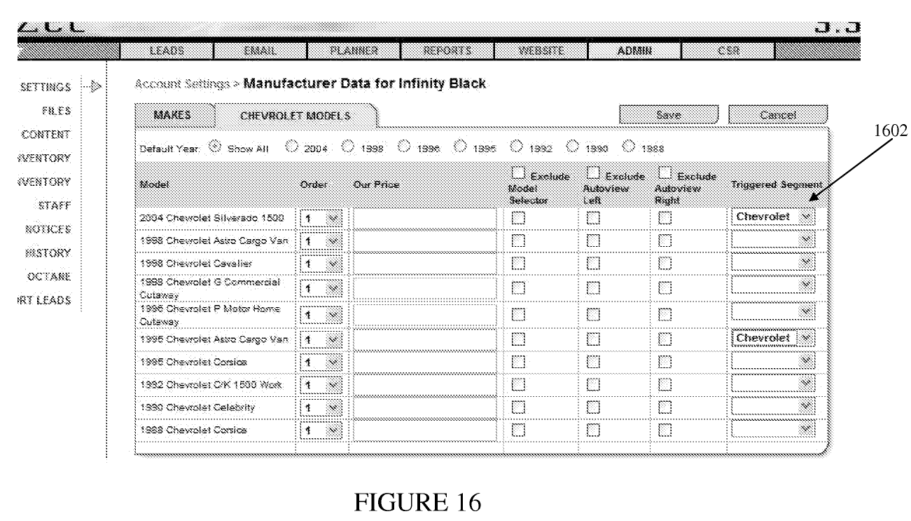

Selecting on any of the rows in the make list in the screen shots in FIGS. 14 and 15 may generate a list of all models of the makes of car that are active for the account. FIG. 16 shows a screen shot of Chevrolet models. A triggered behavioral segment column may be included in this listing. In each row, the trigger column 1602 may contain a drop-down list of available segments to specify as triggered by the specific model.

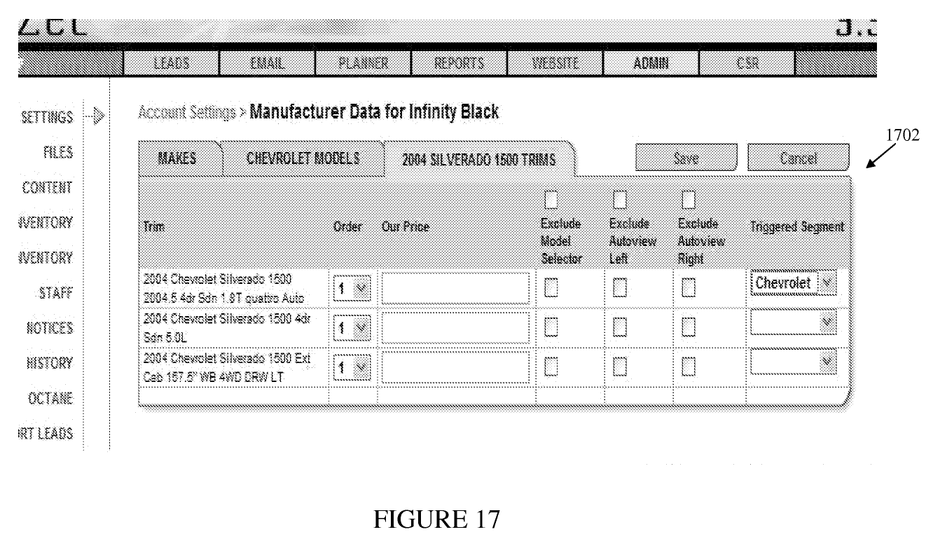

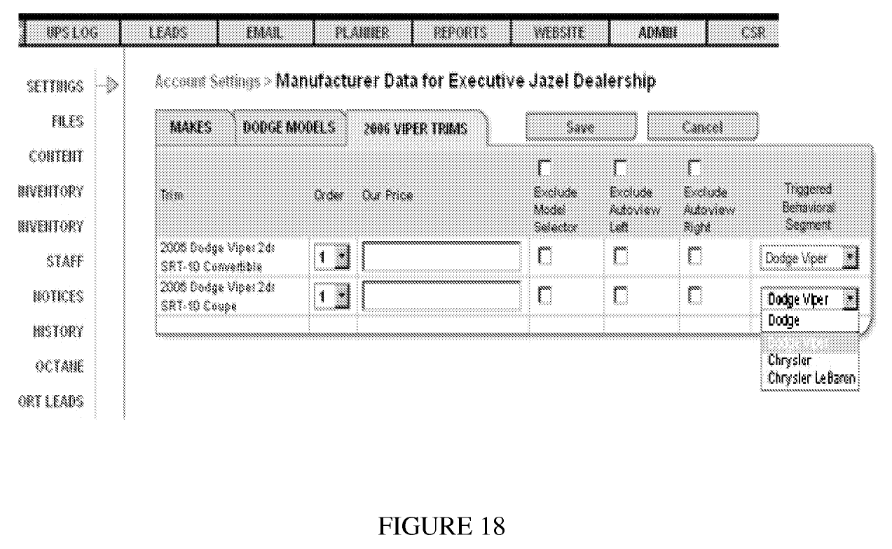

Selecting on any of the rows in the Model list of FIG. 16 generates the list of all trim packages for that model that are active for the website (see FIGS. 17 and 18). A triggered behavioral segment column 1602 and 1702 may be included in this listing. In each row, the trigger column may contain a drop-down list of available segments to specify as triggered by the specific trim. FIG. 16 is another example of a screen shot for trims.

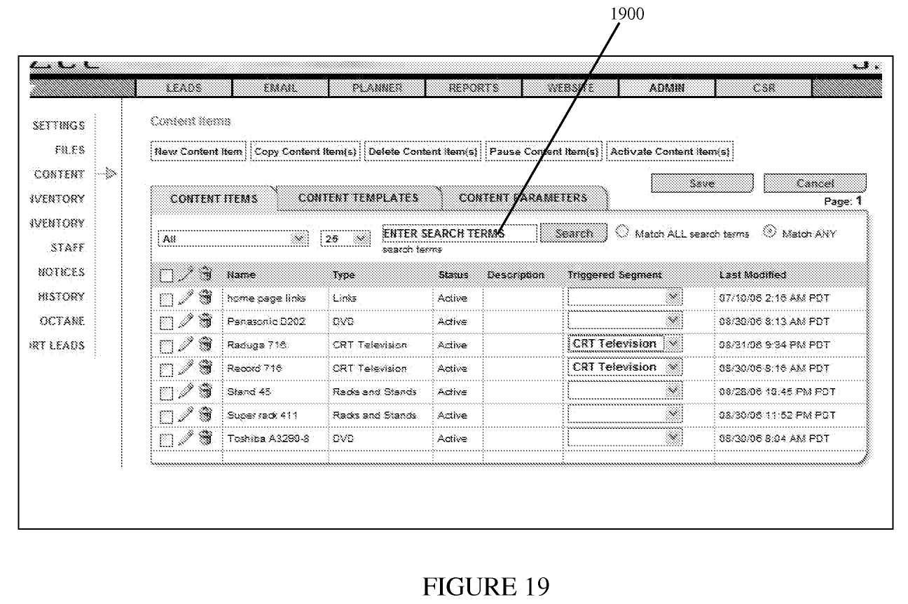

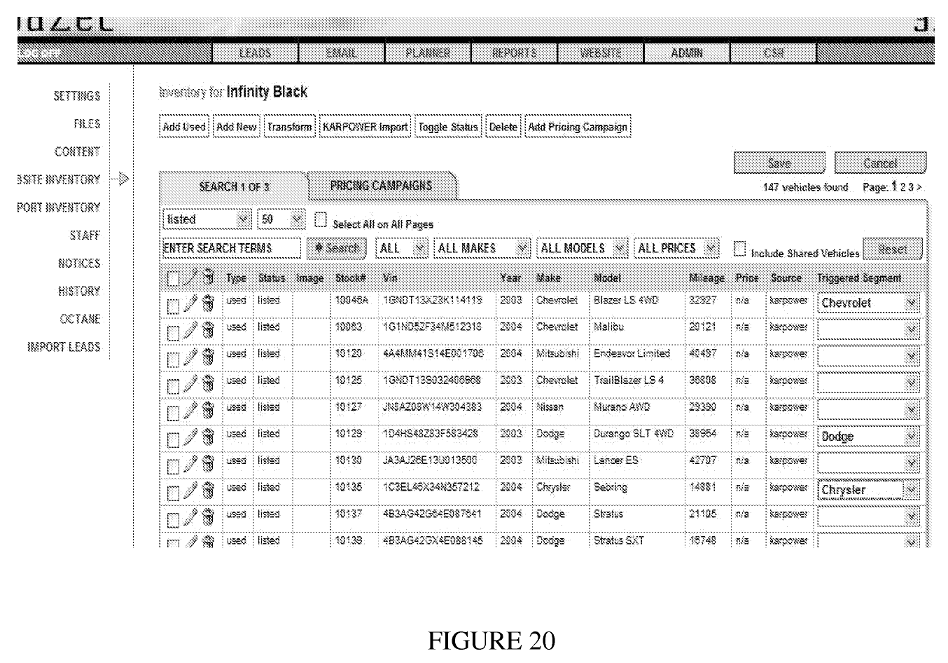

FIG. 19 shows a search screen available to a web administrator. By entering key words 1900, a website administrator can search content items, content templates and content parameters that have been defined. FIG. 20 shows a screen shot of a search that has been generated by the website administrator.

In the present invention, in situations where the system imports or receives external consumer data, the website administrator shall be able to specify behavioral segmentation data in the consumer records. The system shall store this information with the consumer data in the database.

The system of the present invention may provide reports for website administrators to retrieve information regarding BBT tracking, such as a click-stream aggregation report to assist website administrators in determining the best segmentation strategies.

The system of the present invention may use a cookie to identify a returning website consumer and determine that consumer's behavioral segment.

Consumers who arrive at the site from a search engine may be inspected to see if any of the keywords they used to get there are in the trigger list. If one or more of the keywords is a trigger (and there is no segment conflict among the keywords), then the consumer may be assigned to a segment prior to seeing the home page. Targeted content may be served to the consumer on their first visit to the site.

The system of the present invention may set a consumer's behavioral segment for the first time as soon as a visitor views a mapped segmentation trigger. If the consumer is not grouped into a behavioral segment on the first or subsequent visit, then they may remain in the default behavioral segment.

Once a consumer's behavioral segment has been changed from the default segment, it may not be changed back to the default due to any consumer activity. Visiting a segmentation trigger not assigned to a behavioral segment has no effect on the consumer's behavioral segment.

In the present invention, a consumer who clears the cookie (or has permissions set to prevent saving of cookies) is considered a new consumer the next time they visit the site.

If the recency BBT model is in use, the present invention shall change a consumer's behavioral segment when the consumer views a segmentation trigger assigned to a segment other than the one to which the consumer currently belongs. For example, if a consumer belongs to the Dodge® Segment, and then they visit a Chrysler LeBaron® page that has been assigned to the Chrysler® behavioral segment, then that consumer may henceforth be grouped in the Chrysler® behavioral segment.

If the frequency BBT model is in use, the present invention shall change a consumer's behavioral segment when the consumer views a segmentation trigger resulting in a new segment having the highest count of viewed segmentation triggers. For example, if a consumer has visited 3 Dodge® triggers and 3 Chrysler® triggers, and they currently belong to the Dodge® segment, then if they visit a fourth Chrysler® trigger, they may henceforth belong to the Chrysler® behavioral segment.

If the primacy BBT model is in use, the present invention shall set a consumer's behavioral segment once and only once when the consumer first views a segmentation trigger.

When a consumer views a web page containing more than one segmentation trigger and the recency or primacy model is in effect, the behavior-based targeting system operating on a website may assign that consumer to a behavioral segment if and only if all segmentation triggers on the web page are assigned to the same behavioral segment. If there is any conflict between segmentation triggers on a web page, the consumer remains in the current segment.

When a consumer views a page containing more than one segmentation trigger and the frequency model is in effect, the consumer's behavioral segment shall change if after adding in all of the segmentation trigger views on the page, the highest viewed trigger count changes.

If a consumer who belongs to a behavioral segment fills out a form or otherwise converts to a lead, the behavioral segment information shall be stored with the lead.

The Leads List may display and allow filtering/searching by behavioral segment.

In one implementation, once a consumer is assigned to a segment, dynamic content generation is based on current consumer behavior; i.e., consumer behavior in selecting content, categories or links on a current or previously-visited website (based on recency, frequency, and/or primacy) utilizing the present invention. Consumers may be reassigned to new “segments” based on dynamic behavior in selecting content, categories or links on a page.

Unlike the prior art, the present invention need not use prior purchase information or account sign-in to assign a consumer to a “segment” or generate content;

According to one feature, relevant offers may be generated and presented to a consumer based on the segment to which the consumer is assigned and other content selection.

Consumer segmentation may be carried through when the consumer is converted to a lead. When a consumer fills out a form and becomes a lead, that lead is grouped according to the behavioral segment. This grouping can then be used to refine business processes and email campaigning.

In the present invention, email campaigning may allow filtering by behavioral segment.

The present invention may use a leads behavioral segment to determine appropriate business (sales) processes and activities. The business process definition tool may allow behavioral segments to be used to differentiate between Business Processes.

One advantage of the present invention is that dynamic targeted content may be provided on a primary web page to visitors of a web site that belong to a particular behavioral segment.

A large corporation may utilize the present invention, as an example, to segment consumers into five categories: Consumers, Developers, Partners, Advertisers, and Investors. On a first visit to the company's web site, all visitors may be directed to the default page (which is the consumer entry point). Non-consumers may navigate links to find the information they are interested in, be it investor relations, programmer training, or advertising rates. Once they have visited one of these areas of the site, the visitors are grouped into behavioral segments. Henceforth, the home page they see when they come to visit that company is a dedicated entry point for a particular type of visitor. This might be an investor relations or software development portal-type web page or a marketing page for partners or advertisers. Navigation links on each type of page are geared specifically toward the type of visitor, providing them with convenient access to the links they need for their involvement.

### Example Methods and Apparatus

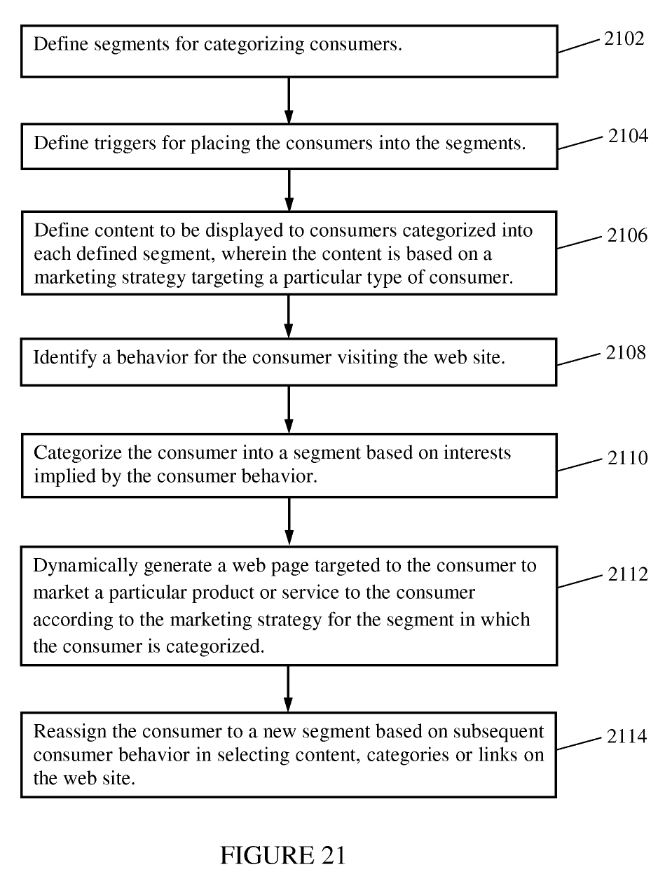

FIG. 21 illustrates a method for implementing targeted online marketing strategies on a web site based on consumer behavior. Segments for categorizing consumers may be defined 2102, for example, by an online retailer or website administrator. Triggers may also be defined for placing the consumers into the segments 2104. In one example, segmentation triggers may include website pages and product-related content that, when viewed or selected by the online consumer, trigger the behavioral segmentation of a consumer. Content to be displayed to consumers categorized into each defined segment are also defined, wherein the content is based on a marketing strategy targeting a particular type of consumer 2106.

Consumer behavior may be identified for the consumer visiting the web site 2108. For instance, such “consumer behavior” include: selection of an initial web page visited or latest web page visited within a web site, a selection within a current web page, the number of times a consumer visits a web page, and/or a search term used to reach a web site or a search term searched within the website. Such “consumer behavior” may be indicative of consumer interests or characteristics that can be utilized in classifying the consumer into a content segment. The consumer may be categorized or classified into a segment based on interests implied by the consumer behavior 2110. The triggers for each segment can be used to define which consumer is placed into which segment. A web page may be dynamically generated so that it is targeted to the consumer to market a particular product or service to the consumer according to the marketing strategy for the segment in which the consumer is categorized 2112. Consequently, rather than being limited to just a plurality of pre-set or pre-defined web pages, any number of web pages can be generated that are specifically customized to a particular user. For instance, the content of the same web page is dynamically modified and displayed to consumers according to the segment into which they are categorized. The system may continually whether the consumer should be reassigned to a new segment based on subsequent consumer behavior in selecting content, categories or links on the web site 2114.

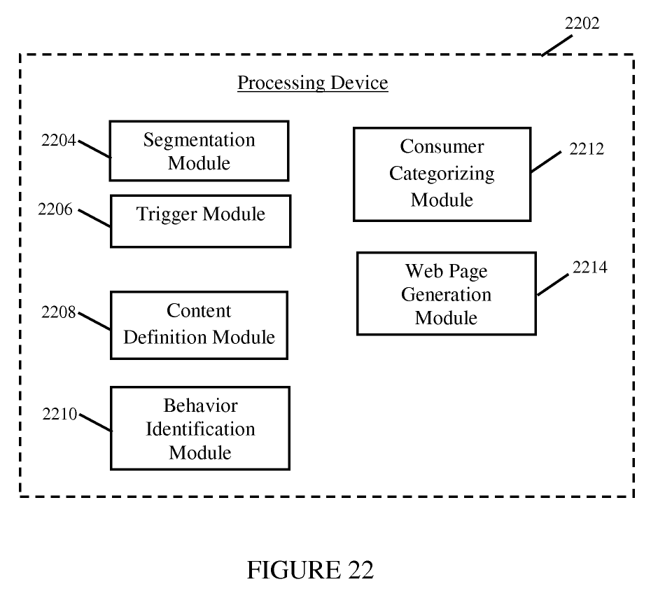

In some examples, the methods described herein may be implemented in hardware, software, and/or a combination thereof, to allow a web administrator to allow dynamically configuring the websites according to each individual consumer's behavior. For example, FIG. 22 illustrates a processing device 2202 that may include a segmentation module 2204, a trigger module 2206, a content definition module 2208, a behavior identification module 2210, a consumer categorizing module 2212, and a web page generation module 2214 that perform one or more of the recited steps.

### Mobile Car Inventory System

A system is provided to facilitate building, maintaining, and/or using a catalog of automobile inventory from a mobile communication device. Generating and maintaining an online catalog of cars is a time consuming and cumbersome task. Oftentimes, such catalog must be updated regularly as cars are sold and new cars acquired by a dealer. Additionally, buyers often wish to view images of all sides of the car to determine if it satisfies their needs.

Additionally, with the ubiquity of mobile communication devices (such as iPhone by Apple Corporation), it would be desirable to integrate such communication devices (e.g., mobile phones with cameras) as part of the inventory collection and access system. In various examples, the features described herein may be implemented for automobile dealerships to maintain car and/or parts inventories, for retail stores inventory, or any other applications where inventories are created and/or maintained.

### Car Inventory Information Collection

One aspect of maintaining automobile inventory is to provide pictures of the available cars from various sides and/or angles. However, doing this with a conventional digital camera is time consuming and burdensome since a set of pictures for each car must be collected and then downloaded (often with operator assistance) to a computer or server and then associated with a particular car in a database. For instance, front view, back view, right view, left view, interior view may be stored in the camera and then manually downloaded to an inventory server and associated with the particular car.

Consequently, the conventional process of building a complete car inventory with images is time consuming, cumbersome, and typically requires operator experience and assistance to complete.

According to a first feature, a mobile communication device may be adapted with an inventory application that is synchronized (either in real-time, via an over-the-air interface, or when docked) with a car inventory stored on a server. Rather than having to download information for one car as needed, the mobile communication device may synchronize with the server (e.g., via an over-the-air interface or when docked) to obtain a copy of the car inventory database or at least a relevant portion of the car database.

The inventory application on the mobile communication device may be adapted to display the inventory via an easy-to-use (e.g., searchable, sortable, filterable, etc.) graphical interface. This interface may also include predefined fields for presenting and/or collecting information for each car in the database.

One feature of the car inventory application allows collecting information for cars at a lot or dealership using the mobile communication device. An operator (e.g., sales person, etc.) may walk the lot and collect information for new cars (vehicle identification number, color, make, model, year, condition, mileage, etc.) on the application running on the mobile communication device. The application simplifies the data collection process by providing input fields on a display screen of the mobile device that the operator fills out. Once filled, the information can be sent to the main server maintaining the inventory database. A corresponding application on the server simply stores the new car information in the inventory database without operator assistance.

An additional feature of the car inventory application operating on the mobile device allows a user to take digital pictures of a car for any view or they can select from the predefined views of a car in the inventory database. For instance, the inventory database may define views from the front, sides, back, inside, etc. The user simply selects the particular car (from the inventory database stored in the mobile communication device), selects the type of image (e.g., left view, right view, front view, back view, inside view, etc.) to be taken, and takes the picture. The picture is stored and associated with the type of image for that particular car. This process may be repeated for all sides of the car. The pictures can then be wirelessly sent (e.g., over a wireless data network, mobile phone network, etc.) to the inventory server (where the main inventory database is maintained) and the website. An application operating on the server automatically stores the pictures and associates them with the particular car and view without the intervention of an operator. Therefore, this automated image collection system for cars may be performed without significant training or assistance from an operator.

An example of how the present inventory application may be used to collect inventory information may include the steps of:
a. Inventory data is automatically sent wirelessly from the inventory application to the mobile communication device;
b. Operator filters the inventory on the mobile communication device to obtain a list of cars for which images are yet to be captured;
c. Operator selects a specific car and the specific view to be captured then takes the picture;
d. Automatically and/or seamlessly send (e.g., wirelessly transmit) images/data from the mobile communication device to the main inventory database server;
e. Automatically associate the received images at the inventory database server with the particular car, without the assistance of an operator; and
f. Automatically update the website inventory without the assistance of an operator.

Consequently, this one-step inventory application makes keeping a website inventory updated a breeze. This solution allows anyone at a dealership to immediately update the dealership's inventory and or car images or photos. Additionally, the car inventory is automatically loaded to the mobile communication device. Simply select the vehicle, take its pictures, and the inventory on the website is automatically updated.

### On-the-Go Full Inventory Access

Another feature of the car inventory application operating on the mobile communication device is that it allows a car sales person to have relatively real-time access to the full inventory of a car dealership anywhere. So, the sales person can search for, select cars, and show information and images for a particular car from any location. Because a version of the inventory database has been copied onto the mobile communication device, it can provide the images for any car in the inventory relatively quick

With the inventory application on the mobile communication device, the complete car inventory can be available in a person's pocket (even when network access is not available). This allows a salesperson to show and/or sell a car even when they are away from a dealership or a computer.

Additionally, the mobile communication device may also provide pricing information, financing information, and other information that facilitates making a deal.

Note that other embodiments of the present invention may serve to create, maintain, and/or access inventories for other types of products (not just cars or car parts). For example, such system may be used within the automobile insurance industry to automatically and transparently obtain images and/or other information for a car (e.g., to establish the original condition of a car at the start of an insurance policy, to document damage to a car after an accident, etc.). In such system, the mobile communication device can collect the desired views of the car and automatically sends them to a main server that stores and/or associates them with the car.

Similarly, this application (operating on the mobile communication device and an inventory server) may be used to create, maintain, and/or access inventories of any type.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine readable mediums for storing information. The terms “machine readable medium” and “computer readable medium” include, but are not limited to portable or fixed storage devices, optical storage devices, and/or various other mediums capable of storing, containing or carrying instruction(s) and/or data.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, circuit, and/or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

One or more of the components and functions illustrated in FIGS. 1, 2, 3, 4, 5, 6, 7, 8, 9, 10, 11, 12, 13, 14, 15, 16, 17, 18, 19, 20, 21 and/or 22 may be rearranged and/or combined into a single component or embodied in several components without departing from the invention. Additional elements or components may also be added without departing from the invention.

While certain exemplary embodiments have been described and shown in the accompanying drawings, it is to be understood that such embodiments are merely illustrative of and not restrictive on the broad invention, and that this invention is not be limited to the specific constructions and arrangements shown and described, since various other modifications may occur to those ordinarily skilled in the art.

What is claimed is:

1. A method for implementing targeted online marketing strategies on a web site based on consumer behavior, the method comprising:
defining segments for categorizing consumers;
defining triggers for placing the consumers into the segments;
defining content to be displayed to consumers categorized into each defined segment, wherein the content is based on a marketing strategy targeting a particular type of consumer;
identifying a behavior for the consumer visiting the web site;
categorizing the consumer into a segment based on interests implied by the consumer behavior; and
dynamically generating a web page targeted to the consumer to market a particular product or service to the consumer according to the marketing strategy for the segment in which the consumer is categorized.

2. The method of claim 1, further comprising:
reassigning the consumer to a new segment based on subsequent consumer behavior in selecting content, categories or links on the web site.

3. The method of claim 1, wherein the consumer behavior is identified by how many times the consumer visits the web site.

4. The method of claim 1, wherein the consumer behavior is defined by at least one of the first and last web page the consumer visited.

5. The method of claim 1, wherein the consumer behavior is defined by the amount of time a consumer spends visiting a particular web page.

6. The method of claim 1, wherein segmentation triggers include website pages and product-related content that, when viewed, trigger the behavioral segmentation of a consumer.

7. The method of claim 1, wherein search terms used by the consumer imply a consumer interests.

8. The method of claim 1, wherein content of the same web page is dynamically modified and displayed to consumers according to the segment into which they are categorized.

9. The method of claim 1, wherein the method is implemented as a software tool that may be configured by web administrators to present their products and/or services on their distinct websites.

10. The method of claim 1, wherein the method is implemented as a software tool that allows defining different marketing or sales strategies and targeted web page content for consumers of different behavioral segments.

11. The method of claim 1, wherein different consumer behavior results on different content being presented for the same web page.

12. A processing device adapted to implement targeted online marketing strategies on a web site based on consumer behavior, comprising:
means for defining segments for categorizing consumers;
means for defining triggers for placing the consumers into the segments;
means for defining content to be displayed to consumers categorized into each defined segment, wherein the content is based on a marketing strategy targeting a particular type of consumer;
means for identifying a behavior for the consumer visiting the web site;
means for categorizing the consumer into a segment based on interests implied by the consumer behavior; and
means for dynamically generating a web page targeted to the consumer to market a particular product or service to the consumer according to the marketing strategy for the segment in which the consumer is categorized.

13. The processing device of claim 12, further comprising:
means for reassigning the consumer to a new segment based on subsequent consumer behavior in selecting content, categories or links on the web site.

14. The processing device of claim 12, wherein different consumer behavior results on different content being presented for the same web page.

15. A method for implementing targeted online marketing strategies based on consumer behavior, the method comprising:
defining segments for categorizing consumers;
defining triggers for placing the consumers into the segments;
defining content to be displayed to consumers categorized into each defined segment, wherein the content is based on a marketing strategy targeting a particular type of consumer;
receiving information related to online behavior for the consumer visiting a web site;
categorizing the consumer into a segment based on interests implied by the consumer behavior; and
sending dynamically generated web page content targeted to the consumer according to the marketing strategy for the segment in which the consumer is categorized.

16. The method of claim 15, wherein the web page is generated in response to a web page request from a user interface.

17. The method of claim 15, wherein the received information relates to consumer behavior in reaching the web site or navigating the website, and different consumer online behavior results on a different content being presented for the same web page.

18. The method of claim 15, wherein the consumer online behavior includes at least one of:
amount of time spent viewing particular content on the web site;
how recently a particular content was viewed;
how frequently a particular content was viewed; and
and what was the first content viewed when arriving at the web site.

19. A method for implementing targeted online marketing strategies based on consumer behavior, the method comprising:
receiving a request from a consumer network device to provide one or more web pages for a web site;
collecting information related to online behavior for the consumer visiting a web site;
sending the collected information for the consumer to a web server;
receiving a dynamically generated web page specifically customized for the consumer based on the collected online behavior; and
providing the received web page to the consumer network device.

20. The method of claim 19, wherein the collected information relates to consumer behavior in reaching the web site or navigating the website, and different consumer online behavior results on a different content being presented for the same web page.
